(19) United States
(12) Patent Application Publication
(10) Pub. No.: US 2011/0107417 A1
(43) Pub. Date: May 5, 2011

(54) Detecting AP MAC Spoofing

(76) Inventors: Rajini I. Balay, Fremont, CA (US); Jeremy Bennett, San Carlos, CA (US); Kal Prabhakar, San Jose, CA (US)

(21) Appl. No.: 12/609,992

(22) Filed: Oct. 30, 2009

(51) Int. Cl. G06F 11/00

(52) U.S. Cl. 726/22

(57) ABSTRACT

Detecting access point MAC spoofing in a wireless digital network. A sensor in a wireless digital network learns the MAC address and operating channel for at least one access point. If the sensor detects frames being sent to a MAC address on a channel other than the channel associated with that MAC address, then the access point associated with the MAC address is being spoofed. These frames may be association frames, or data frames. If the sensor is running as part of an access point the sensor also knows what clients are associated with the access point. If the sensor detects frames indicating association, such as data frames, sent to its MAC address, but the client is not associated with the access point, then the access point is being spoofed. Similarly, if the sensor receives frames on a channel other than that associated with the access point and receives traffic for the access point's MAC address, the access point is being spoofed. The sensor may be a separate device on the wireless network, or may be functionality included in one or more access points on the network.

### BACKGROUND OF THE INVENTION

The present invention relates to digital networks, and in particular, to the problem of detecting spoofing of access points in a digital network.

Wireless digital networks commonly consist of a set of access points which may or may not be connected to a controller. Each access point supports a number of clients. In most situations, each access point connects to its controller using a wired connection, for example using 803.2 Ethernet.

In such wireless networks, each access point (AP) is identified by a media access controller (MAC) address unique to the access point. This MAC address is used to advertise the access point's capabilities and to communicate with any clients associated with it. This MAC address is used in the 802.11 frames which are sent between the AP and its clients, as defined in the IEEE 802.11 specification.

A malicious user may attack the AP and/or the client by transmitting 802.11 frames to the client impersonating the AP by spoofing or copying the AP's MAC address. Such attacks may cause the client to disconnect from the real AP, lose data frames from the real AP, or may even cause the client to associate to the malicious device spoofing the real AP.

Traditional MAC spoofing detection mechanisms rely on receiving frames from the impersonating or spoofing AP. These mechanisms will not work if an AP that is implementing MAC spoofing detection cannot receive the spoofed frames. This is a kind of “hidden transmitter” problem all too common in wireless networks. As an example, assume an AP is inside a building, and a wireless client is at the edge of the building. Also assume a malicious device spoofing the AP is located in the building parking lot. The client device can receive frames from both the real AP and the malicious device, but the real AP is unable to receive frames from the malicious device.

What is needed is a mechanism for detecting AP MAC spoofing when spoofed frames transmitted by a malicious device cannot be received.

### BRIEF DESCRIPTION OF THE DRAWINGS

The invention may be best understood by referring to the following description and accompanying drawings that are used to illustrate embodiments of the invention in which:

FIG. 1 shows a wireless network.

### DETAILED DESCRIPTION

Embodiments of the invention relate to methods of detecting MAC address spoofing in a digital network, particularly in an environment in which the access points which implement MAC spoofing detection cannot receive the spoofed frames. In an embodiment of the invention, a sensing function is implemented in the network. The network has one or more access points (APs) each of which supports one or more client devices. The sensing function may be implemented in one or more separate sensing units, or as a built-in capability of one or more access points (APs). In operation, the sensing function scans channels in the network and receives frames transmitted by other devices. The sensing function has a table containing entries for at least one access point in the network. Each table entry contains information on an access point, including at least the MAC address and operating channel. Other information may also be kept in the table, such as operating parameters, BSSIDs, encryption status, 11n bandwidth, and the like. If the sensing function receives a frame containing the MAC address of a known access point on a channel other than the channel listed for that MAC address in the table, the access point is being spoofed. Similarly, if information from the received frame is inconsistent with the information on the access point from the table, spoofing has been detected. Received frames may be data frames, or frames used in creating an association to an access point. If the sensing function is being performed on the access point, then the sensing function also has a list of clients associated with the access point. In this case, if the sensing function receives data frames containing the MAC address of the access point from a client which is not associated with the access point, then the access point is being spoofed. The table may be maintained by the sensor function, such as in the dedicated sensing units, or in an access point. The table may also be maintained by a controller supporting the sensing units and/or access points. Sensing units and/or access points performing the sensing function may also send frames to the controller where tests for inconsistencies with information stored in the table, those inconsistencies denoting spoofing, are performed. Spoofing once detected may be logged to the controller or other service.

Note that while the invention is described in terms of IEEE802.11 wireless networks, it is equally applicable to other digital networks having devices with individual MAC addresses and channelized operation, such as Bluetooth networks and cable networks operating under DOCSIS standards.

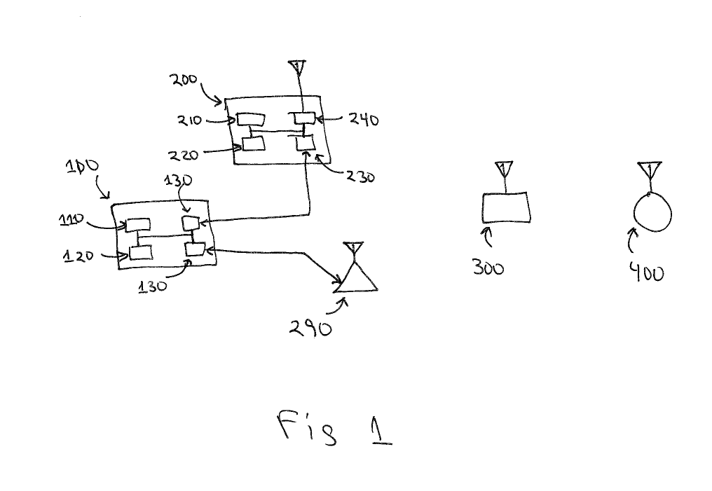

FIG. 1 shows a wireless network in which access point 200 provides wireless services to one or more wireless client devices 300. Access point 200 may operate on its own, or it may operate through controller 100.

Access point 200 is a purpose-built digital devices having a CPU 210, memory hierarchy 220, a first wired interface 230, and wireless interface 240. The CPU commonly used for such access nodes is a MIPS-class CPU such as one from Raza Microelectronics or Cavium Networks, although processors from other vendors such as Intel, AMD, Freescale, and IBM may be used. Memory hierarchy 220 comprises read-only storage such as ROM or EEPROM for device startup and initialization, fast read-write storage such as DRAM for holding operating programs and data, and permanent bulk file storage such as compact flash memory. Memory hierarchy 220 may also contain a Trusted Platform Module (TPM) for storing security certificates, licenses, and the like. Access point 200 typically operates under control of purpose-built programs running on an embedded operating system such as Linux or VXWorks. Wireless interface 240 is typically an interface operating to the family of IEEE 802.11 standards including but not limited to 802.11a, b, g, and/or n. As is understood in the art, each wired and radio interface has a unique MAC address. These MAC addresses are used according to IEEE 802.11 protocols to identify among other things the source and destination of information and are contained in transmitted frames.

Similarly, controller 100 if present is also a purpose-built digital device, with an architecture having a CPU 110, memory hierarchy 120, and a plurality of wired interfaces 130. The CPU commonly used for such controllers is a MIPS-class CPU such as one from Raza Microelectronics or Cavium Networks, although processors from other vendors such as Intel, AMD, Freescale, and IBM may be used. Memory hierarchy 120 comprises read-only storage such as ROM or EEPROM for device startup and initialization, fast read-write storage such as DRAM for holding operating programs and data, and permanent bulk file storage such as compact flash memory. Memory hierarchy 120 may also contain a TPM. Controller 100 typically operates under control of purpose-built programs running on an embedded operating system such as Linux or VXWorks. Wired interfaces 230 are IEEE 802.3 Ethernet interfaces.

In an embodiment of the invention as shown in FIG. 1, a sensing function is provided by sensor 290, a separate device on the network from access point 200. This sensing device is similar in architecture to access point 200, but operates as a receiver. Sensor 290 scans available wireless channels. Sensor 290 contains a table of information on access points such as access point 200. This table may be stored, for example, in memory 220. The table contains at least MAC addresses and assigned channels for access points 200. The table may also include other information on the operation of access points 200 such as encryption mode, BSSID, preambles, 11 n connection type, and other operating parameters. Sensor 290 may receive this information from controller 100, from access points 200, or from analysis of traffic to and from access points 200.

In typical operation, there will be multiple sensors 290 in a wireless network, as well as multiple access points 200. Each sensor 290 will keep a table of information for access points 200.

In operation according to an embodiment of the invention, sensor 290 receives frames on a channel. Sensor 290 examines the data in received frames with respect to its table of access points. Note that for the purposes of the invention, the channel on which the frame was received is considered part of the frame. Frame information is compared to the corresponding table entry to check for discrepancies. As an example, assume the table indicates access point 200 has MAC address m and is operating on channel 6. If sensor 290 receives a frame on channel 44 with a destination MAC address m, the only way this can occur is if some device, such as attacker 400, is spoofing MAC address m on channel 44. Thus sensor 290 can detect the presence of spoofing by attacker 400 without directly receiving frames from the attacker. Similarly, if sensor 290 receives a frame on channel 44 being sent by MAC address m, this is also an indication of spoofing, as the device with MAC address m, access point 200, is operating on channel 6, not channel 44. Presence of traffic with a MAC address on a channel not legitimately operating on that channel indicates an attacker spoofing the MAC address on that channel. Similarly, other discrepancies between received frames and table data such as encryption mode, preambles, BSSIDs, and the like indicate the presence of an attacker spoofing a MAC address.

The frames in question may be data frames, indicating a connection between a client device and an attacker, or may be association frames setting up a connection between a client and an attacker. Discrepancies between the contents of the received frame and the corresponding information stored in the table for the corresponding MAC address indicate spoofing of the MAC address. For example, as previously indicated, receiving frames sent to or from a MAC address on a channel not associated with that MAC address further denotes spoofing. Incorrect encryption mode, or incorrect 11n connection type, for example a 40 MHz connection to a MAC address which only handles 20 MHz connections further denotes spoofing.

In a second embodiment of the invention, the sensing function is built into access point 200. This may be done, for example, by adding a separate receiver to access point 200 for use by the sensor function, or by multi-tasking the existing receivers in access point 200, occasionally switching them among other channels for the sensor function. In this embodiment, with the sensor running in access point 200, the sensor now has access not only to a table of access points and their operating parameters, but also has access to the list of associated client devices and their MAC addresses which are connected to access point 200. If access point 200 receives a data frame to its MAC address, indicative of a client associated to access point 200, but that client is not currently associated to access point 200, then an attacker such as attacker 400 must be spoofing access point 200 on its operating channel.

In a third embodiment of the invention, information from captured frames, from sensor 290, from access point 200 acting as a sensor, or a combination, are sent to controller 100, which verifies the information in those frames against tables of access point configuration and connected users kept by the controller.

When spoofing is detected, as an example in sensor 290 or access point 200 acting as a sensor, this information may be sent using standard protocols to controller 100, or to a dedicated monitoring and/or logging address on the network.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of detecting MAC address spoofing in a digital network operating on a plurality of channels, the digital network having at least one access point, comprising:
keeping a table of operating parameters for at least one access point in the digital network wherein the operating parameters include at least the MAC address of the access point and the channel used by the access point,
receiving a frame at a sensor in the digital network,
comparing frame information to information in the table, and
signaling that spoofing has occurred when an inconsistency is detected between frame information and information in the table.

2. The method of claim 1 where the sensor receiving the frame is a dedicated sensor on the network.

3. The method of claim 2 where the step of comparing frame information to information in the table is performed in the dedicated sensor.

4. The method of claim 1 where the sensor receiving the frame is an access point on the network.

5. The method of claim 4 where the step of comparing frame information to information in the table is performed in the access point.

6. The method of claim 1 where the step of comparing frame information to information in the table includes the step of sending at least a portion of the frame information to a controller connected at least to the sensor and where the comparison is performed in the controller.

7. The method of claim 1 where the table is maintained by the sensor.

8. The method of claim 1 where the table is maintained by a controller connected at least to the sensor.

6. Software for detecting MAC address spoofing a digital network operating on a plurality of channels, the digital network having at least one access point, comprising:
a sensor for receiving frames on a channel in the digital network,
a comparator for comparing the received frame information with information in a table, wherein the table contains information on at least the one access point, and
a signaler for signaling a spoofing event when received frame information is inconsistent with the table information,
wherein the sensor, comparator, and the signaler are software digitally encoded in a computer readable medium executable by a computing device, which causes the computing device to perform a set of actions for which the sensor, comparator, and the signaler are configured.
